(19) United States
(12) Patent Application Publication
(10) Pub. No.: US 2008/0018097 A1
(43) Pub. Date: Jan. 24, 2008

(54) SECURE LAMINATED CARDS

(75) Inventors: Kenneth Wicker, Honeoye Falls, NY (US); Michael Scott Caton, Oakfield, NY (US); Michael P. Caulley, Redwood City, CA (US); Jaeson M. Caulley, Foster City, CA (US)

Correspondence Address: Stephen B. Salai, Esq.;Harter, Secrest & Emery LLP, 1600 Bausch & Lomb Place, Rochester, NY, 14604-2711, US

(73) Assignee: DOCUMENT SECURITY SYSTEMS, INC., Rochester, NY (US)

(21) Appl. No.: 11/774,464

(22) Filed: Jul. 6, 2007

Related U.S. Application Data
(60) Provisional application No. 60/831,462, filed on Jul. 18, 2006.
(60) Provisional application No. 60/831,228, filed on Jul. 17, 2006.
(60) Provisional application No. 60/818,543, filed on Jul. 6, 2006.

(51) Int. Cl. B42D 15/10

(52) U.S. Cl. 283/91; 283/94

(57) ABSTRACT

Laminate document include line screen patterns for authenticating the documents. The line screen patterns can hide information in the documents that can be revealed by a viewer. Print densities of the line screen patterns can be adjusted to compensate for effects associated with lamination. A built-in viewer can be spaced from the line patterns to shift image intensity or color through rapid cycles of moire interference with changes in viewing angle.

### CROSS-REFERENCE TO RELATED APPLICATIONS

This application is a non-provisional of U.S. Provisional Application No. 60/818,543 filed on Jul. 6, 2006, U.S. Provisional Application No. 60/831,228 filed on Jul. 17, 2006, and U.S. Provisional Application No. 60/831,462 filed on Jul. 18, 2006, which applications are hereby incorporated by reference.

### TECHNICAL FIELD

This invention relates generally to document protection methods and products. More specifically, the invention relates visual identification and verification of documents, particularly laminated cards, such as ID cards, and to providing anti-copying features to such laminated cards.

### BACKGROUND OF THE INVENTION

Secure documents have been produced in the past by letterpress, offset, and intaglio printing processes, including such processes adapted for embedding hidden information or security images. The hidden information or security images, often referred to as latent images, are printed so as to be effectively invisible to the unaided eye but can be detected using various optical enhancements. Document embedded security features deter counterfeiting of valuable papers, important records, product packaging, ID documents, and financial instruments such as checks, currency, and credit cards so that original documents can be verified and unauthorized copies of these documents can be readily distinguished from the originals.

The latent images, which can contain covert information or other indicia such as security codes, graphics, or information within the original documents, can be hidden within visually integrated settings so as to be practically invisible to the unaided eye under normal viewing conditions. Such settings for hiding the latent images range from simple background tints to the remainders of composite images within which the latent images are hidden. However, the latent images are otherwise distinguishable through the use of a visual aid, such as a magnifier or reader. Upon reproduction, such as by scanning or otherwise copying of the originals, the latent images can be arranged either to disappear or to become more pronounced. That is, either the absence of the latent image or the visible presence of the latent image in a copy can be construed as an indication of a non-original document.

Such latent images can be produced by embedding one line-screen pattern within another line-screen pattern. Each of the line-screen patterns can be formed by an array of print elements, such as dots, dashes, line segments, or other elemental shapes, in an arrangement of systematically spaced lines (curved, wavy, or straight). The two line-screen patterns can be formed or otherwise camouflaged so as to be indistinguishable from one another to the unaided eye, but can differ in some respect that can be optically exploited for viewing the latent image. For example, the two line-screen patterns can be printed in the same color and at the same print density but can differ in orientation or line frequency.

A first line-screen pattern can be printed in defined areas having one or more shapes for forming the latent image. A second line-screen pattern can be printed throughout an adjoining or an enlarged area forming a visually integrated setting, such as a complementary background or a remaining portion of a composite image. Each of the two line patterns can be formed by a plurality of line patterns in different colors so long as the multiple line patterns that form the latent image match the color and overall appearance of the one or more line patterns that form the visually integrated setting.

Although invisible to the unaided eye, the latent images can be detected by various optical enhancements such as through optical overlays that increase contrast between the latent images and their visually integrated settings. For example, viewers (readers) containing screen patterns that match one of the underlying screen patterns of the latent images or their visually integrated settings can fill in or obscure one line pattern with respect to another.

In addition to the authentication and validation of originals, the latent images can also be used to distinguish copies from originals. For example, the latent images themselves can be rendered visible by copying for revealing messages such as “void” or “unauthorized copy” on the reproductions. Alternatively, the latent images can be arranged so as not to reproduce, so the absence of the latent image indicates a copy.

Laminated documents present special challenges for hiding latent images so as not to be readily visible to the naked eye yet reproducing the latent image in a visible form on copies. Overlayers of the laminate can act as diffusing filters or blurring layers between a scanning device and the actual printing (or printed image) causing the processes not to work successfully. Improvements are also envisioned for verifying document authenticity based on the use of latent images or other print constructs without waiting for the results of a photocopy.

### SUMMARY OF THE INVENTION

Among certain embodiments, the invention provides enhanced security for documents, particularly laminated cards, through the use of latent images. Improved methods are also contemplated for visually verifying such documents.

For example, a substrate can be embossed or debossed with a latent image within a visually integrated setting so as not to be easily detected by the naked eye. The substrate can be made of paper, plastics, PVC, laminates, or aluminum foil. The embossed images on the substrate can be composed of screen patterns formed by embossed or debossed elements in the form of lines, dots, dashes or other elemental shapes arranged into arrays of systematically spaced lines (curved, wavy, or straight).

The embossed images on the substrate can be of predetermined frequencies and angles and can be covered by one or more layers of at least partially transparent plastic laminate or glass. A viewer (reader) containing engraved or otherwise printed patterns having a corresponding frequency and angle can be registered with the underlying composition either an integral part of one of the layers overlying the substrate or as a separate body that can be moved into alignment with the hidden images on the substrate. The print patterns of the viewer can be formed by clear or opaque ink, or embossed or engraved on a transmissive film or plate.

The invention also includes embodiments that provide for visual identification and verification of laminated cards and the like. For example, the invention includes methods for protection of laminated cards from scanning or copying.

According to one such embodiment of the invention, a substrate is printed with a background tint of print density of 5% to 90%, preferably 10%-40%, or any combination of colors. The substrates can be of paper, plastic, PVC, laminates, or aluminum foil. The background can be printed on the substrate at a line frequency of about 75-210 lines per inch (lpi) and preferably 85-120 lpi. The lines (curved, wavy, or straight) can be formed from lines, dots, spots or the like at any line angle.

Hidden words or indicia (latent images) can be placed in chosen areas of the background that have been ‘carved’ out of the background layer. The indicia can have the same or different lines per inch as the background and can be formed from lines, dots, spots or the like at any line angle but generally not the same angle as the background.

The substrate can be formed as a laminate, and at least some of the area of the laminate above the indicia can be embossed with a plate, dye, or stamp with a matching line frequency and angle to that of the indicia beneath it such that the embossment will register with the underlying composition, hence enabling verification by revealing a combined image.

The invention also contemplates improvements to the design and manufacture of hidden images in a laminated card. A substrate, which can be composed of paper, plastic, PVC, laminates, and aluminum or plastic foil, holds an image that cannot easily be detected by the naked eye. The image can be ‘hidden’ in a background on the substrate. Both the image and the background in which the image is hidden can be composed of lines and/or dots or other elements. The hidden image and background are relatively oriented with respect to each other through an angle of at least 5 degrees and preferably about 45 degrees to each other.

Preferably, the background is composed of dots or other discontinuous line elements with a line frequency of about 130 to 210 lines per inch (lpi) and most preferably about 170 to 190 lines per inch (lpi). In addition, the background has a tint of about 5% to 50%. Most preferably, the background has a tint of about 10% to 20%. The tint can be composed of any number of colors, but preferably, a single color is used for the background. The latent images are preferable made of lines at a line frequency of 40 to 110 lpi and most preferably between 75-95 lpi. The hidden words or other indicia of the latent images can have a tint value that is slightly more or less than background, preferably 1%-30% greater or less than the background tint to compensate for variations in line frequency, print element form, or other parameters affected by the application of color to the substrate and any subsequent lamination of the substrate to further embed the color.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWING FIGURES

The invention is, herein, described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

The present invention will be more fully understood and appreciated from the following detailed description, taken in conjunction with the drawings, in which:

FIG. 1 is a simplified illustration of the present invention showing where latent images are embossed;

FIG. 2 is a simplified illustration of an embossed document or card viewed without the assistance of a dedicated viewer;

FIG. 3 is a simplified illustration of an embossed document or card viewed through a viewer rendering the letter ‘W’ “visible”;

FIG. 4 is a simplified illustration of an embossed document or card viewed through a viewer rendering the background “visible” and having the ‘W’ drop out of vision;

FIG. 5 is a simplified illustration of the present invention showing a file make up of indicia to be printed on a background;

FIG. 6 is a simplified illustration of an embossed plate to match the indicia;

FIG. 7 is a simplified illustration of an embossed laminated card with the indicia barely visible;

FIG. 8 is a simplified illustration of an embossed laminated card in which the indicia seem to be floating and flickering when tilted back and forth; and

FIG. 9 is a simplified illustration of the present invention showing a background pattern and a hidden word or image.

FIG. 10 is a front view illustration of a card with an image subject to flashing with small changes in viewing angle.

FIG. 11 is an enlarged side view of the flashing card showing the assembly of layers.

FIG. 12 is a schematic illustration relating the spacing between line screen patterns, the pitch of the patterns, and a change in angle of view to a single cycle of moiré interference.

FIG. 13 is a side view showing an assembly of substrates within a press for forming line screen patterns with hidden images within a laminate.

FIG. 14 is a front view illustration of the laminate of FIG. 13, showing a latent image hidden within a background.

FIG. 15 is a similar front view illustration of a copy of the laminate of FIGS. 13 and 14 as reproduced by a conventional copier.

### DETAILED DESCRIPTION OF THE INVENTION

The present invention provides a method and product for visual identification and verification of items such as product packaging, identification cards, and tickets. The present invention relates to but is not limited to cards or the like manufactured from paper, plastic, PVC, laminates, or aluminum.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways, such as laminates or holographic foils. Also, it is to be understood that the phraseology and terminology employed herein is for the purpose of description and should not be regarded as limiting.

In a preferred embodiment of the present invention an image is embossed or debossed, using particular line and/or dot frequencies and angles that can be read through a matching reader placed above or integrally formed in layers above the image.

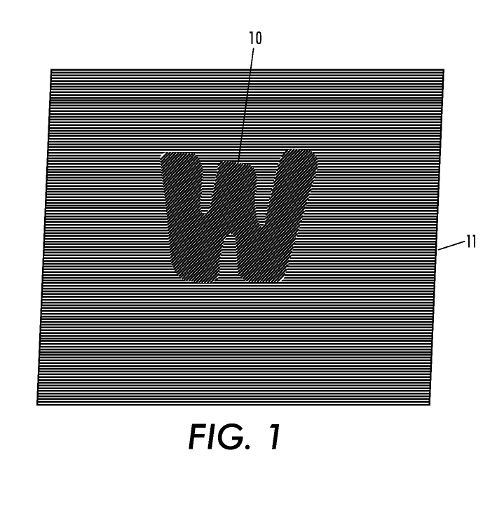

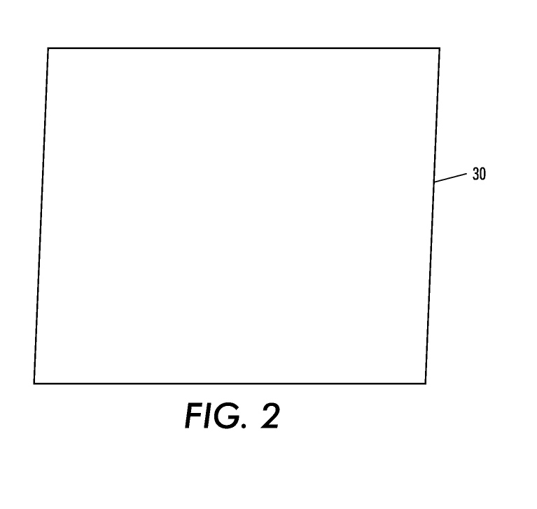

Reference is now made to FIG. 1, which is a simplified illustration of the present invention showing where latent “invisible” images are embossed. A latent image 10, in this instance the letter ‘W’, is embossed (or debossed) onto a substrate layer 11 shown with a 45 degree angle of line frequency of about 100 lines per inch (lpi), which would be matched with a corresponding viewer (not shown) of approximately 100 lpi onto a substrate. The ‘W’ image 10 here is shown as black lines only for simpler understanding, as it is virtually invisible when viewed from above (FIG. 2). The latent image 10 can be in the form of a logo, word, or plurality of indicia, which when eventually viewed, can relay, for example, a message of authenticity to a user wishing to authenticate the document or identification card. A background 40 oriented at a 0 degree angle is shown as black lines only for simpler understanding, as it is virtually invisible when viewed without a dedicated viewer.

Reference is now made to FIG. 2, which contains a simplified illustration of an embossed document/card 30 as seen by the naked eye without a corresponding viewer.

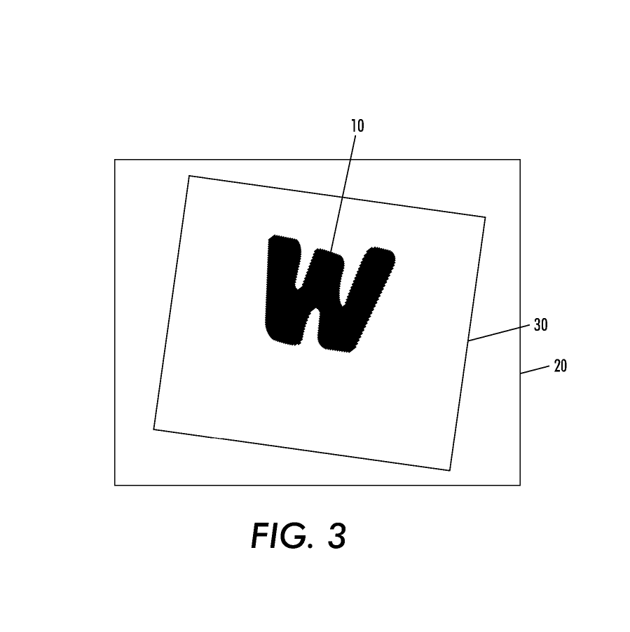

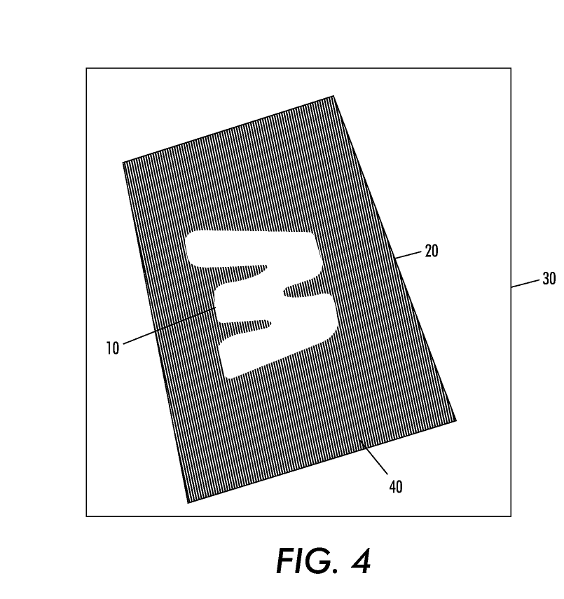

Reference is now made to FIG. 3, which is a simplified illustration of an embossed document/card 30 viewed through a viewer 20 rendering the ‘W’ image 10 “visible”, and to FIG. 4 which is also a simplified illustration of an embossed document/card 30 viewed through a viewer 20 rendering the background 40 “visible” and having the ‘W’ image 10 drop out of vision.

The image can be viewed through a viewer 20, which can be a set of substantially transparent lines (curved, wavy, or straight) positioned at a predefined frequency and angle, and layered on top of the image. The viewer 20 can be an integral part of one of the layers above the substrate or can be an entirely separate reader.

When a viewer 20 that corresponds to the background 40 is placed over the designated area of the document/card 30, the background 40 can be viewed while the ‘W’ image 10 drops away because either the angle, frequency, or shape of the lines in the viewer do not match the ‘W’ image 10. This acts as a “negative”.

A result of the embossments not containing any visible ink on the substrate is that it would be extremely difficult to copy a document or card containing such an embossment.

In another embodiment of the present invention, an image is printed on a background on a substrate. The laminate above the indicia is embossed or debossed, using a matching line and/or dot frequencies and angle such that the indicia can be seen when the laminated card is tilted back and forth.

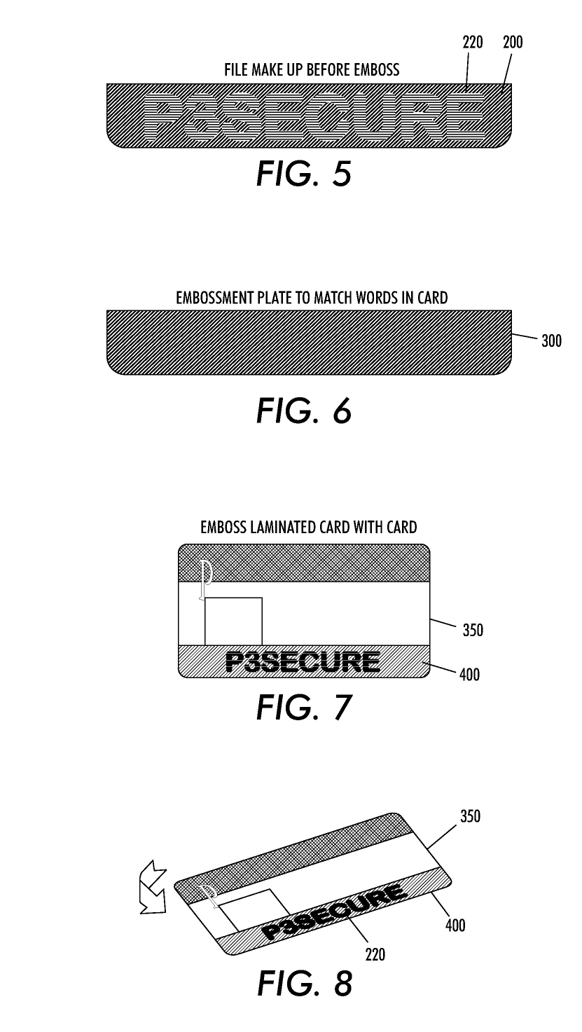

Reference is now made to FIG. 5, which is a simplified illustration of the present invention, showing a file make up of a background 200 with indicia 220 placed inside the background 200. A program such as Forms X6 for Quark Xpress by DigiComp, Maple Grove, Minn. can be used to create such a file. In the file on layer one, the background 200 is created having a tint of about 5% to 90% and more preferably a tint of 10% to 40%, which can be of any color. Background 200 will preferably have a line frequency of 75 to 210 lines per inch (lpi) and more preferably will be 85 to 120 lpi. The lines (curved, wavy, or straight) may be composed of lines, dots, or spots and may be of any angle. In FIG. 5, for example, the background 200 contains lines that are at an approximately 45-degree angle.

In the file, a second layer is created that is ‘carved’ out of the background layer 200. This second layer may be used to create a word, indicia, or image that is to be printed on the same substrate as the background 200. The indicia (i.e., latent image) 220 will preferably but not necessarily have the same lpi as background 200. Indicia 220 can comprise lines (curved, wavy, or straight) that are made up from lines dots or spots or the like and most preferably have a tint value that may be slightly more or less (e.g., between 1% and 30% more or less) than that of background 200. The preferred tint of the indicia can be determined, for example, by a press test with the background 200 and hidden message 220 combined at various densities in the hidden message 220 and laminated to find an optimum tint percentage to use.

Hidden message 220 is created in the file to have any line angle that is significantly different to that of background 200. The hidden message 220 of FIG. 5 has an approximately 0-degree angle and is therefore oriented about 45° different from background 200. A 90° angle is another preferred angle for indicia 22. In an alternative embodiment, the indicia 220 can also be printed on the back of the laminate to be formed on top of the substrate.

The file that has been created with the background 200 and indicia 220 is then printed to a substrate that is used for a laminated card production such as but not limited to microporous silica-filled polyethylene sold as TESLIN® by PPG Industries, Inc of Pittsburgh, Pa., or any other substrate known to those skilled in the art.

The substrate is then laminated with a clear of variably opaque plastic layer which is known to those skilled in the art. Typical laminates can be polyvinyl chloride, microporous silica-filled polyethylene, polyethylene tetraphtalate, polycarbonate, acrylonitrile -butadiene-styrene, and polyesters.

Reference is now made to FIG. 6, which is a simplified illustration of an embossment plate 300 that may be used to emboss the laminated card. The embossment plate has lines that match both the frequency and angle of indicia 220. For example, the angle of the lines in figures is approximately 0°, which matches the angle of indicia 220 shown in FIG. 5. Embossment can be facilitated by the use of a embossing plate, die, or stamp with matching line frequency and angle as hidden word, indicia, or image 220.

Reference is now made to FIG. 7, which is an illustration of a laminated and at least partially embossed card 350 that has a bottom area 400 containing a background 200 with indicia (not seen in FIG. 6 but may be faintly recognized by the naked eye). The area on the laminate above the bottom area is embossed by using embossment plate 300 (FIG. 6).

Reference is now made to FIG. 8 which is of a laminated and at least partially embossed card 350 that has a bottom area 400 containing a background 200 with indicia. When card 350 is tilted back and forth, indicia 220 seem to flash and flicker. This provides card 350 with a built-in verifier or authenticator that does not require an external verifier.

In a preferred embodiment of the present invention a latent image formed substantially of lines (curved, wavy, or straight) is created by blending it into a background consisting substantially of dots. Both the latent image and the background are printed onto a substrate, which is then laminated.

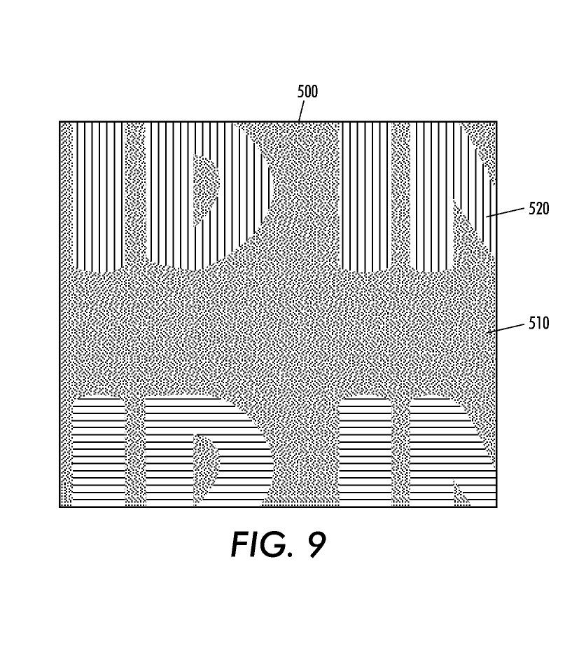

Reference is now made to FIG. 9, which is a simplified illustration of the present invention showing where latent images 520 are printed onto a substrate 510 that has a background 500. Most preferably, a background is created by using a software program, such as Forms X6 for Quark Xpress by DigiComp, Maple Grove, Minn. Preferably, a background 500 has a tint of about 5% to 50%. More preferably, the background 500 has a tint of about 10% to 20%. The background 500 is formed of dots or spots. The tint may be composed of any number of colors. Preferably, a single color is utilized as a background. Preferably, the background 500 has a line frequency of about 130 to 210 lines per inch (lpi). More preferably, the background 500, which can be arranged to ‘hide’ the latent image 520, forms a background tint and has a line frequency of about 170 to 190 lines per inch (lpi).

Indicia of a latent image 520 are created of lines (curved, wavy, or straight) that are at about a 45-degree angle in relation to the background 500. Indicia of a latent image 520 are placed in areas of background 500, which have been ‘carved’ out of background layer 500. These images or hidden words 520 are preferable made of lines at a line frequency of 40 to 110 lpi and more preferably between 75-95 lpi. Preferably, hidden words 520 have a tint value that is slightly more or less than background 500, preferably 1%-30% greater or less than the background tint. This can be determined by a simple press test with the background and hidden message repeated on substrate over a gradation of densities and laminated to find the right tint percentage to use.

Hidden message 520 may also have a line angle of at least 45 degrees in relation to background 500 in two or more directions (preferably 0 degrees and 90 degrees). Using two or more line frequencies is also possible. These files can be printed to a substrate 510 common to the ID card industries such as Tesilin, polyester, or PVC.

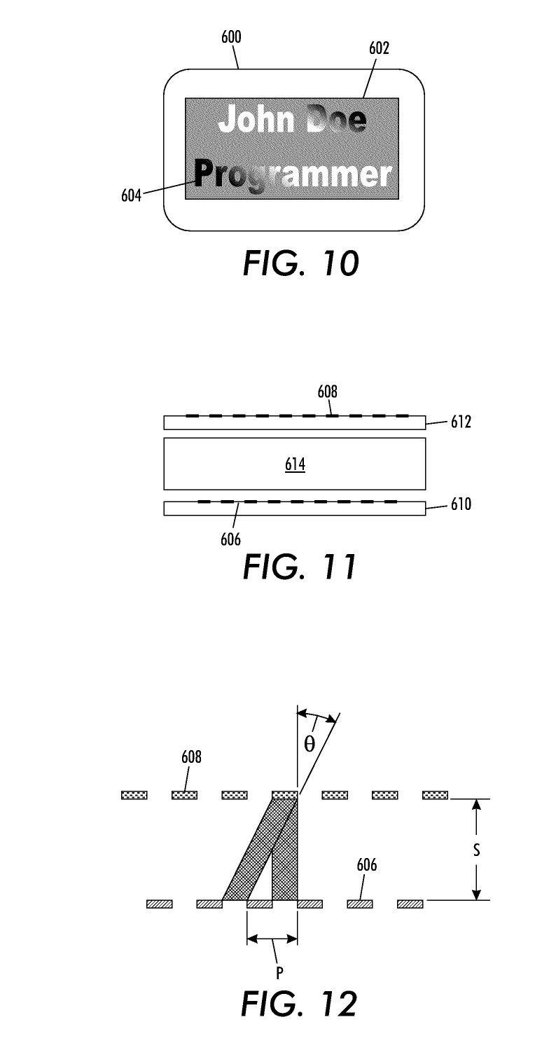

Another embodiment of the invention is shown in FIGS. 10-12 as a self-verifying card 600 containing images 602 and 604 that appear to float, flash, move, or otherwise change as a result of changes in viewing angle “θ”. The changes in the appearance of the images 602 and 604 are as a result of moiré effects accompanying changes in the viewing angle “θ” through two offset line-screen patterns 606 and 608.

The images 602 and 604 are printed as line-screen patterns 606, which can be similar to the line-screen patterns of the preceding embodiments. However, the line screen patterns 606 of the images 602 and 604 can be printed with or without a background or other visually integrated setting. If printed with a background, an additional screen pattern (not shown) for a latent image is preferably embedded in the background similar to the preceding documents to provide a separate means for verifying the authenticity of the card 600. Although shown in text form, i.e., as “John Doe Programmer”, the images can 602 and 604 can be in the form of single or multiple graphics or pictures.

The line-screen pattern 606 is printed on a first substrate 610, and the line-screen pattern 608 is printed or otherwise formed on a transmissive second substrate 612. The line-screen pattern 608, which is preferably matched in line frequency and orientation to the line-screen pattern 606, is preferably embossed (or debossed) into the surface of the second substrate 612 but could also be printed with clear or opaque ink. A transmissive third substrate 614 joins the first and second substrates 610 and 612 together through heat sealing or other bonding technologies and spaces the two line-screens 606 and 608 apart through a distance “S”. Thus, the first substrate 610 holds the images 602 and 604, the second substrate 612 forms an integral viewer or reader for producing moiré interference effects with the images 602 and 604, and the third substrate provides a spacer for separating the line-screen pattern 608 of the viewer from the line screen pattern 606 of the images 604 and 606. The substrates can be made of various plastics or other materials including PVC, polyester, or acrylic glass (PMMA).

The spacing “S” between the line-screen patterns 606 and 608 cooperates with the changes in viewing angle “θ” for effectively displacing one line-screen 606 with respect to the other 608 in the direction of view. An effective displacement of one pitch “P” of the line-screen pattern 606 completes one cycle of moiré interference, shifting the images 602 and 604 (or portions thereof) from dark to light and back to dark or visa versa.

For example, FIG. 12 shows the change in viewing angle “θ” required to shift the viewing position of the line-screen pattern 608 through one pitch “P” of the line-screen pattern 606. Starting at normal incidence, the images shift from dark, where the spaces between printed lines are covered and the printed lines are exposed, to light, where the printed lines are covered and the spaces are not, and back to dark at the viewing angle “θ”, where again the spaces between printed lines are covered and the printed lines are exposed.

The moiré effects through one or more cycles of interference preferably occur through the normal handling or use of the card 600. That is, the desired moiré effects should be apparent without requiring deliberate or special tilting of the card 600 through large angles. For example, as a badge, the flashing effects should be apparent to an observer of a person wearing the badge exercising a normal walking motion. The card, should also readily flash or otherwise shift through one or more cycles of interference when normally handled, such as when shifting from a horizontal position to a position normal to the direction of view.

Preferably, the images 602 and 604 should shift through one or more cycles of interference through changes in viewing angle between 5 degrees and 15 degrees, but more preferably, the interference shifts occur within 5 degrees to 10 degrees. More rapid shifts with viewing angle can lead to flickering, which may be desirable in certain circumstances but are generally not as visually appealing. Slower shifts with viewing angle may not be apparent at all unless deliberate motion is applied.

To achieve the desired flashing rates through a prescribed change in viewing angle “θ”, the spacing “S” between the line-screen patterns 606 and 608 can be set as follows:

$$S = \frac{P}{tan θ}$$

where “θ” is the change in viewing angle from normal incidence.

Thus, at a line frequency of 100 lpi and a corresponding pitch of 0.01 inches, a spacing “S” of 0.037 inches is required to achieve one complete cycle of moiré interference with a change in viewing angle of 15 degrees, and at a line frequency of 200 lpi and a corresponding pitch of 0.005 inches, a spacing “S” of 0.019 inches is required to achieve one complete cycle of moiré interference with a change in viewing angle of 15 degrees. Also at a line frequency of 100 lpi, a spacing “S” of 0.057 inches is required to achieve one complete cycle of moiré interference with a change in viewing angle of 10 degrees, and a spacing “S” of 0.114 inches is required to achieve one complete cycle of moiré interference with a change in viewing angle of 5 degrees.

The line screen patterns 606 and 608 are preferably oriented at approximately 45 degrees to horizontal so that tipping the card 600 about either orthogonal axis (i.e., vertical or horizontal axes) results in similar transitions through cycles of moiré interference (although the effective pitch is somewhat increased). Additional matching line screen patterns can be formed on the separated substrates 210 and 212 to flash other images or to favor flashing in other directions. The line screen patterns 606 and 608 can be printed in different colors such as magenta and cyan to effect color transitions through each cycle of interference. Alternatively, the line screen patterns can be printed with parallel lines of more than one color so the underlying colors are variously obscured or combined through each cycle of interference with an embossed viewer. The line screen pattern of the viewer could also be aligned with a background screen pattern so the background screen pattern flashes around a stationary or differently flashing image.

Although the card 600 is shown constructed of three substrates 610, 612, and 614, more or less substrates can be used to make similar cards or other documents. For example, the line-screen patterns 606 and 608 could be printed on opposite sides of a single substrate that has a thickness equal to the desired spacing “S”. The spacer itself can be a transmissive solid or can form an opaque window frame supporting an empty or otherwise transmissive gap between substrates supporting the line screen patterns 606 and 608 at the desired spacing “S”. The spacer and viewer could also be combined into a receptacle, such as a lanyard case, for receiving a substrate 610 printed with one or more of the desired images 602 and 604 in a position of alignment with the viewer.

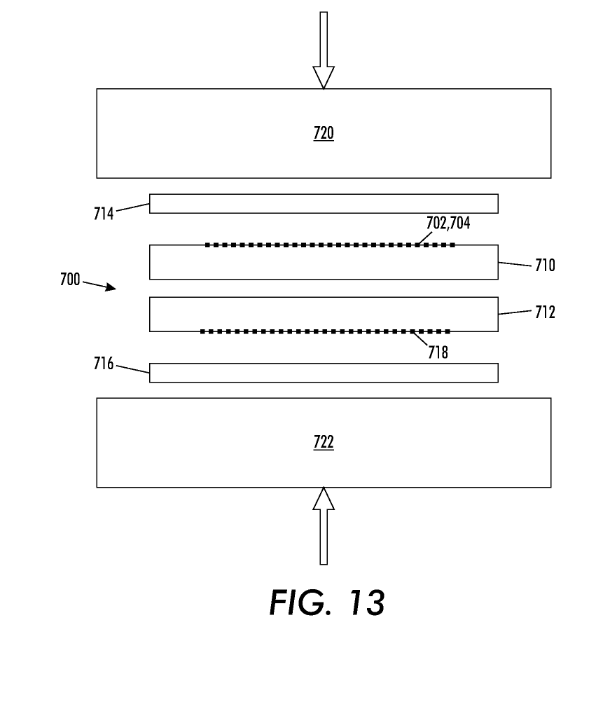

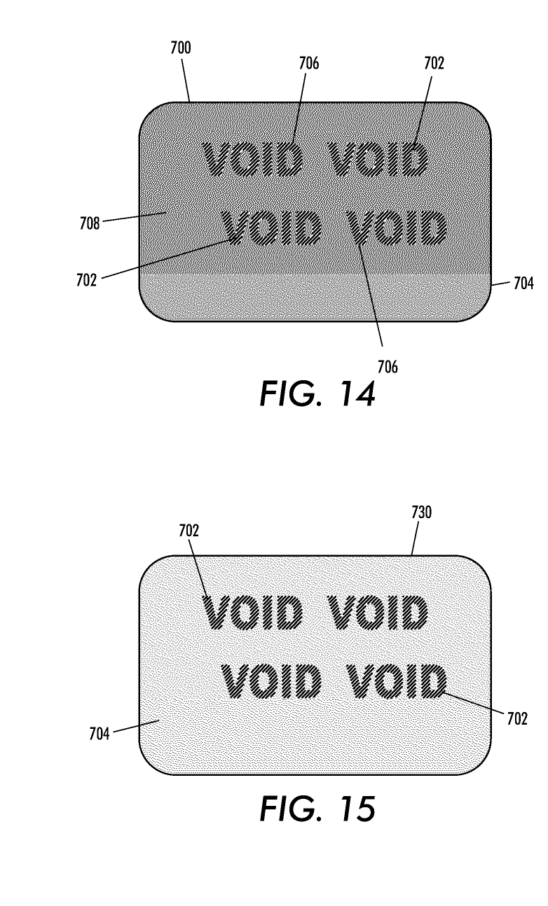

Another laminate construction in the form of a card 700 is shown in FIGS. 13 and 14. Latent images 702 depicting the word “VOID” are hidden within a background 704 using respective line screen patterns 706 and 708, which are intended upon lamination to appear on the card 700 as the same color tone and shade. However, upon copying, visual contrast is increased for clearly revealing the latent images 702 on the copies 730.

The line screen pattern 706 for forming the latent images 702 is assembled from print elements in the form of straight-line segments, and the line screen pattern 708 for forming the background 704 is preferably assembled from print elements in the form of dots or other localized elements. The line-screen pattern 706 of the latent images 702 has a line frequency of nearly one-half of the line frequency of the line-screen pattern 708 of the background. The preferred line frequency for the latent images 702 is around 95 lines per inch and the preferred line frequency for the background is around 180 lines per inch.

The two line screen patterns 706 and 708 forming the latent image 702 and the background 704 are printed on an opaque (e.g., white) plastic substrate 710, such as PVC or polyester. Similar line screen patterns or other printing 718 can be applied to the opposite side surface of another opaque (e.g., white) plastic substrate 712, such as PVC or polyester. Clear or otherwise transmissive protective substrates 714 and 716, which can also be made of PVC or polyester, overly the printing on the opaque substrates 710 and 712. The ink is preferably an ultraviolet curable ink so as to be set prior to lamination. Glossy PVC is preferred over matte surfaces to support higher temperature laminations.

The entire stack of substrates 710, 712, 714, and 716 are laminated together between press plates 720 and 722 under conditions of heat and pressure. For example, pressure can be applied to the stack in the range of 1000 pounds per square inch at a temperature between 245 degrees and 270 degrees Fahrenheit for bonding the substrates 710, 712, 714, and 716 together. An adhesive can be incorporated between the substrates to bond areas covered by non-bonding inks. Such laminating processes are well understood and standards developed for making such laminates as plastic credit and ID cards.

Although the latent images 702 are intended to be hidden within the background 704 on the finished card 700, the screen pattern 706 having the lower line frequency is printed at a lower print density (e.g., at 15-17 percent density) than the screen pattern 708 having the higher line frequency (e.g., at 19 percent density). As a result, the lower line frequency latent images 702 are visible on press, as being lighter than the higher line frequency background 704. However, we have discovered that upon lamination, compression of the ink and the underlying and overlying substrates, together with a softening of the substrates produces a differential effect between the line frequencies that relatively increases the apparent density of the lower line frequency latent images 702 with respect to the higher line frequency background 704. The reduced print density of the lower line frequency latent images 702 with respect to the higher line frequency background 702 during printing is equated to the apparent gain in print density accompanying the subsequent lamination so that the latent images 702 remain hidden to the unaided eye on the finished card 700.

Upon copying, as shown in FIG. 15, the latent images 702 relatively increase in contrast with respect to the background 704. Line screen patterns of around 180 lines per inch are generally ideal for “dropping out” or reproducing in a lighter form. We have also found that line screens composed of dot elements lighten even better than line screens composed of line elements under conditions of lamination. The significantly lower line frequency screen patterns of the latent images can be matched to a range of copiers to darken, fill in, distort, or otherwise increase in contrast with respect to the background.

Although shown as a stack of four substrates 710, 712, 714, and 716, more or less substrates can be used. However, the final combination of substrates is preferably symmetric to reduce any tendency of the card 700 to curl. The line-screen patterns 706 and 708 can together form a background tint, texture, or overall graphic form over which visible printing or other structures (e.g., magnetic tape) can be applied. Substrates of different materials can also be incorporated into the laminate, but the latent images and their visually integrated settings (e.g., background) are preferably applied to plastic materials that subject the line screen patterns to relative changes in apparent print densities upon lamination

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination, such as a card with specific “hidden” information revealed at least partially by an embossed laminated “viewer” permanently affixed to the card.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

1. A self-authenticating laminate comprising
a first line-screen pattern formed on a first surface for producing an image,
a second line screen pattern formed on a second surface in registration with the first the line-screen pattern for shifting the image through cycles of moiré interference with changes in viewing angle, and
the second line screen pattern being spaced apart from the first line screen pattern through a distance sufficient to shift the image through at least one complete cycle of moiré interference with a change in viewing angle of 15 degrees or less from normal incidence.

2. The laminate of claim 1 in which the spacing “S” between the first and second line-screen patterns is equal to or greater than a quotient of a pitch distance “P” between lines of the first line-screen pattern and a tangent of a desired change in viewing angle “θ” as follows:
$$S = \frac{P}{tan θ}$$

3. The laminate of claim 2 in which the first and second surfaces are formed on opposite sides of a common substrate that transmits visible light between the first and second line-screen patterns.

4. The laminate of claim 3 in which the common substrate has a thickness of “S” or larger.

5. The laminate of claim 1 in which the first and second surfaces are located on first and second substrates, and a third substrate that transmits visible light is located between the first and second surfaces.

6. The laminate of claim 5 in which the first, second, and third substrates are fixed together in overlapping positions.

7. The laminate of claim 2 in which the pitch “P” is at least 0.005 inches and the spacing “S” is at least 0.018 inches.

8. The laminate of claim 2 in which the pitch “P” is at least 0.01 inches and the spacing “S” is at least 0.037 inches.

9. The laminate of claim 1 in which the first and second surfaces are located on first and second substrates that are fixed together in overlapping positions.

10. The laminate of claim 9 in which the second substrate has a thickness of “S” or larger.

11. The laminate of claim 1 in which at least one of the first and second line-screen patterns is formed by form variations in the first and second surfaces.

12. The laminate of claim 1 in which the first line screen pattern is printed in ink on the first surface and the second line-screen pattern is formed by form variations in the second surface.

13. The laminate of claim 1 in which the first line screen pattern is printed with multiple colors of ink so that a complete cycle of moire interference involves a change in visible color.

14. The laminate of claim 1 in which the first line screen pattern is printed in one color and the second line screen pattern is printed in a different color so that a complete cycle of moire interference involves a change in visible color.

15. The laminate of claim 1 in which the laminate has vertical and horizontal axis and the first and second line screen patterns are inclined to both axes.

16. A method of making a verifiable laminate comprising steps of:
printing line screen patterns having differing line frequencies on a first substrate for embedding a latent image within a visually integrated setting, and
laminating a transmissive second substrate to the first substrate for locating the line-screen patterns between the two substrates,
wherein the line-screen pattern having the lower line frequency is printed at a lower density than the line-screen pattern having the higher line frequency so that the latent image is distinguishable from the visually integrated setting to the unaided eye upon printing but is substantially indistinguishable from the visually integrated setting to the unaided eye upon laminating the two substrates together.

17. The method of claim 16 in which the line frequencies of the line-screen patterns differ so that upon digital copying of the laminate, one line-screen pattern contrasts with the other line-screen pattern to an extent that the latent image is distinguishable from the visually integrated setting to the unaided eye.

18. The method of claim 17 in which the relative reduction in print density of the lower line frequency screen pattern with respect to the higher line frequency screen pattern accompanying the printing of the lower and high line frequency screen patterns is matched to a relative increase in apparent density of the lower line frequency screen pattern with respect to the higher line frequency screen pattern accompanying the laminating of the two substrates together.

19. A verifiable laminate comprising
first and second substrates,
the first substrate being printed with line-screen patterns having differing line frequencies for embedding a latent image within a visually integrated setting,
the first and second substrates being laminated together locating the line-screen patterns between the first and second substrates, and
the line-screen pattern having the lower line frequency being printed at a lower density than the line-screen pattern having the higher line frequency so that prior to lamination, the lower line frequency line-screen pattern appears lighter than the higher line frequency line-screen pattern, and after lamination, the lower density, lower line frequency line-screen pattern appears as substantially the same color tone as the higher density, higher line frequency line-screen pattern.

20. The laminate of claim 19 in which the latent image is distinguishable from the visually integrated setting to the unaided eye upon printing but is substantially indistinguishable from the visually integrated setting to the unaided eye upon laminating the two substrates together.

21. The laminate of claim 20 in which the screen pattern of the visually integrated setting has a line frequency between 175 lines per inch and 185 lines per inch.

22. The laminate of claim 21 in which the screen pattern of the visually integrated setting is formed by an array of dot elements.

23. The laminate of claim 20 in which the screen pattern of the latent image has a line frequency less than 100 lines per inch.
